(19) United States
(12) Patent Application Publication
(10) Pub. No.: US 2021/0146524 A1
(43) Pub. Date: May 20, 2021

(54) UNIVERSAL STARTER HANDLE GRIPPING DEVICE

(71) Applicant: Charles L. Volkema, JR., Winter Garden, FL (US)

(72) Inventor: Charles L. Volkema, JR., Winter Garden, FL (US)

(21) Appl. No.: 16/683,933

(22) Filed: Nov. 14, 2019

(51) Int. Cl. B25G 1/10; F02N 3/02; B25G 3/00

(52) U.S. Cl. CPC B25G 1/102; B25G 3/00; F02N 3/02

(57) ABSTRACT

A starter handle gripping device includes a hand grip having a width that is suitable for receiving a human hand, a pair of elongated arms that extend from both ends of the handle and a coupler for engaging the starter handle. The hand grip, arms and coupler include a one-piece construction, and the arms are diagonal in relation to the handle. The coupler includes a pair of generally U-shaped fingers that are integrally formed onto the ends of the two elongated arms, and a cross member for maintaining a separation distance between the ends of the arms. The second end of each of the arms includes a separation distance that is complementary to a width of a cord cavity of the starter handle, and each of the fingers includes a width that is complementary to a thickness of the upper portion of the starter handle.

### TECHNICAL FIELD

The present invention relates generally to starter handles, and more particularly to an ergonomic gripping device that can be removably secured to any starter handle.

### BACKGROUND

The statements in this section merely provide background information related to the present disclosure and may not constitute prior art.

Gasoline powered engines are used to power numerous kinds of devices such as outboard boat motors, motorcycles, all-terrain vehicles and power tools (i.e. chain saws, weed cutters, lawn mowers, snow blowers, leaf blowers, pumps, generators, garden tillers, etc.), for example. In most instances, these engines have a manual starter mechanism employing a pull cord with an attached handle to allow a user to provide the initial impetus to start the engine.

As is known, the pull cord is wound around a starter pulley that is connected to the engine's crankshaft. To start the engine, a use must grip the handle and quickly pull the same in order to unwind the cord from the pulley and impart a rotational movement to the crankshaft, which (eventually) starts the engine.

In this regard, conventional starter handles typically comprise a simple T-shaped body having a centrally located cavity that is connected to the pull cord. As such, users grasping the handle must separate their fingers to allow placement along both sides of the centrally located pull cord. Although these handles have been used for decades, there have been many injuries associated with their use.

For example, depending on the size of the motor, many starter handles are not wide enough to allow an adult user to fully grip the handle with their entire hand. As a result, users must attempt to grasp and start the engine using only two fingers. Such a situation is difficult for many users suffering from carpel tunnel syndrome and/or those who have injuries to a particular finger.

In addition to the above, many users have become severely injured while pulling the starter handle due to engine kickback or breaking of the starter cord. In such situations, the close proximity of the handle to the motor, combined with the sudden tension (or lack thereof) as the user is pulling the cord, causes the users fully exposed hand to impact the motor components. In many documented instances, this impact has been severe enough to cause amputation of one or more of the user's fingers.

Accordingly, it would be beneficial to provide a universal starter handle gripping device that can provide separation between a user's hand and an engine, while also providing protection against impact with foreign objects. It would also be beneficial if the gripping device can be used with any type of engine starter handle in a removable manner so as to not require permanent installation of the same.

### SUMMARY OF THE INVENTION

The present invention is directed to a starter handle gripping device that can be removably engaged to any type of motor starter handle. One embodiment of the present invention can include a hand grip having a width that is suitable for receiving a human hand. An optional grip cover such as foam can be positioned along the hand grip to aid in the comfort and ergonomics of the device. A pair of elongated arms can extend from both ends of the handle and can terminate into a coupler for engaging the starter handle. The hand grip, arms and coupler can preferably include a one-piece construction, and the arms can be diagonal in relation to the handle.

In one embodiment, the coupler can comprise a pair of generally U-shaped fingers that are integrally formed onto the ends of the two elongated arms, and a cross member for maintaining a separation distance between the ends of the arms.

In one embodiment, the second end of each of the arms can include a separation distance that is complementary to a width of a cord cavity of the starter handle. Likewise, each of the fingers can include a finger width having a dimension that is complementary to a thickness of the upper portion of the starter handle.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the Starter Handle Gripping Device in accordance with one embodiment of the invention.

FIG. 2 is a side view of the Starter Handle Gripping Device in accordance with one embodiment of the invention.

FIG. 3 is a perspective view of the Starter Handle Gripping Device in operation, and in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component.

As described throughout this document, the term “about” “approximately” and “Substantially” shall be used interchangeably to describe a feature, shape or measurement of a component within a tolerance such as, for example, manufacturing tolerances, measurement tolerances or the like.

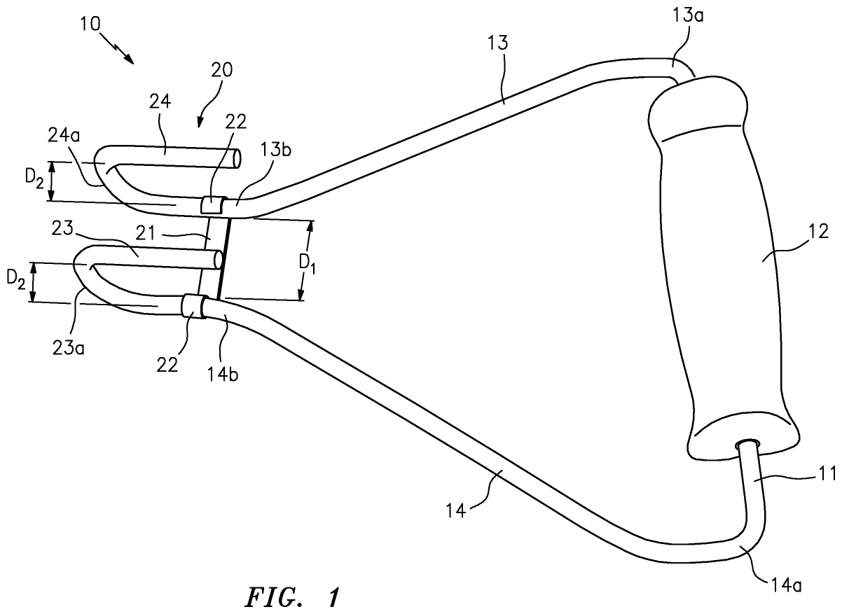

FIGS. 1-3 illustrate one embodiment of a universal starter handle gripping device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

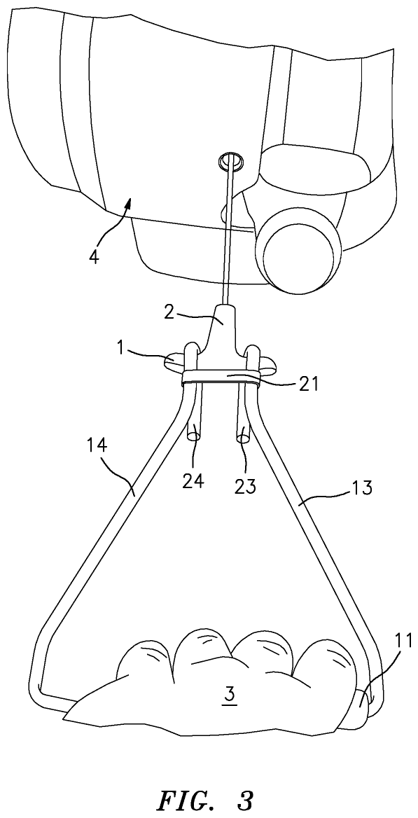

As shown best in FIGS. 1 and 2, the device 10 can include an elongated generally triangular-shaped main body having a hand grip section 11, arm sections 13 and 14, and a handle coupler 20. In the preferred embodiment, the device 10 can be formed from a single one-piece continuous elongated body.

The hand grip section 11 is designed to receive the entire hand of a user while employing the device 10 to impart a pulling force onto an engine starter handle. In the preferred embodiment, the hand grip 11 can include an elongated, generally planar member that is connected to the top end of the elongated arms at both ends. As described herein, the hand grip section 11 may be formed from materials that are, for example, relatively strong and stiff for their weight. Several nonlimiting examples include, but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various composite materials, for example.

In one embodiment, an ergonomic grip cover such as foam padding 12, for example, can be positioned along a portion or an entirety of the hand grip 11. The ergonomic cover material can function to provide a larger surface area for the hands of a user to grasp, and can reduce finger strain and discomfort that would otherwise be encountered by a user of the device. Of course, any number of other cover materials are also contemplated. Moreover, in various embodiments, the grip cover can further include a plurality of protrusions and/or indentations for individually receiving each of the user's fingers.

The device arms 13 and 14 are designed to maintain a safe separation distance between the hand grip 11 and the engine starter handle 1, when the handle is engaged by the below described coupler 20. As such, each of the arms 13 and 14 can preferably include elongated members having first ends 13a and 14a that are connected to the hand grip 11, and second ends 13b and 14b that are connected to the coupler 20.

In one embodiment, each of the arms can extend away from the hand grip 11 in a generally diagonal orientation with the second ends including a separation distance D1 that is less than the separation distance of the first ends. As described herein, the elongated arms can preferably be constructed from the same material as the handle; however, any number of other construction materials are also contemplated.

The coupler 20 can function to removably engage the starter handle of a motor without requiring the user to physically touch the handle. In one embodiment, the coupler 20 can include a cross member 21 and a pair of generally U-shaped fingers 23 and 24.

The cross member 21 can be positioned parallel to the hand grip 11 and can serve two specific functions. First, the cross member can limit or otherwise prevent independent movement or separation of the arms 13/14 and 23/24, thereby preventing unintentional disengagement of a motor handle that is connected to the coupler. Second, the cross member can provide a continuous second point of contact for engaging a starter handle that is connected to the coupler, as will be described below.

In one embodiment, the cross member 21 can include curved ends 22 for engaging the device arms 13/14 so as to be removable in nature. Such a feature being beneficial for allowing a user to manually pull apart/increase the separation distance D1 between the arms so as to accommodate starter handles having non-uniform sizes. Of course, other embodiments are contemplated wherein the cross member is permanently connected.

In one embodiment, each of the fingers 23 and 24 can include a central bend 23a/24a and distal ends 23b and 24b, respectively. The central bend functioning to maintain a width/separation distance D2 between the distal ends of the fingers 23b/24b and the arms 13/14, respectively that is suitable for receiving a motor starter handle as shown below (i.e., finger width).

Although described above as including specifically shaped fingers and a cross member, other embodiments of the coupler are also contemplated. To this end, the coupler 20 can also include, comprise or consist of any number of different elements that are capable of repeatedly engaging a starter handle in a nonpermanent manner and imparting a pulling force onto the same. Several nonlimiting examples include various shaped hooks, tethers, and/or buckles, for example.

FIG. 3 illustrates one embodiment of the device 10 in operation. As shown, the top portion of the starter handle 1 can be positioned horizontally between the fingers 23-24, with the cord cavity 2 of the starter handle positioned vertically between the fingers. When so positioned, the cross member 21 engages the side of the handle and prevents the fingers from separating beyond the width of the handle.

Next, the user simply grasps the hand grip 11 with their hand 3 and imparts a pulling motion on the same. Once the engine 4 has started, the user can remove the starter handle from the device and use the equipment as normal.

Owing to the specific intended use of the device, the following preferred dimensions are important to ensure universal functionality with motor starter handles. As such, it is preferred that the handle section 11 include a length (e.g., distance between upper arm sections 13a and 14a) of approximately 6 inches. Such a length being suitable for receiving an average sized hand of an adult which is typically 3.5 inches in width.

In the preferred embodiment, the separation distance D1 between the second ends of the arms is approximately 1 inch. Such a dimension being complementary to the average width of the cord cavity of known starter handles.

In the preferred embodiment, the separation distance/finger width D2 of the fingers 23b and 24b can each be approximately 1 inch. Such a dimension being complementary to the average thickness of the top portion of known starter handles.

In the preferred embodiment, the length of the elongated arms (e.g., distance between arm sections 13a/13b and 14a/14b the “safe distance”) of approximately 8 inches.

Accordingly, the universal starter handle gripping device 10, ensures the users hand always remains a minimum distance from the starter handle, and the motor itself, thus preventing injuries to the hand caused from cord breakage or motor kickback. Moreover, because the arms 13 and 14 are located on the outer edge of the handle 11, the arms can protect the user's hand from striking external objects during device use.

As described herein, one or more elements of the handle gripping device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A starter handle gripping device, comprising:
a hand grip having a first end and a second end;
a first elongated arm having a first end that is connected to the first end of the hand grip and a second end that is not connected to the hand grip;
a second elongated arm having a first end that is connected to the second end of the hand grip and a second end that is not connected to the hand grip; and
a coupler that is connected to the second end of the first elongated arm and the second end of the second elongated arm, said coupler having a shape and size that is suitable for engaging a starter handle.

2. The device of claim 1, wherein each of the first elongated arm and the second elongated arm extend away from the hand grip at a diagonal angle.

3. The device of claim 2, wherein the second end of the first elongated arm and the second end of the second elongated arm are separated by a first distance.

4. The device of claim 3, wherein the first distance comprises:
a distance that is complementary to a width of a cord cavity located on the starter handle.

5. The device of claim 4, wherein the first distance is approximately one inch.

6. The device of claim 1, wherein the coupler comprises two generally U-shaped fingers.

7. The device of claim 6, wherein each of the U-shaped fingers include a finger width that is complementary to a thickness of a top portion of the starter handle.

8. The device of claim 7, wherein the finger width is approximately one inch.

9. The device of claim 1, further comprising:
a grip cover that is positioned along the hand grip.

10. The device of claim 9, wherein the grip cover is constructed from foam padding.
